(19) United States
(12) Patent Application Publication
(10) Pub. No.: US 2001/0042069 A1
(43) Pub. Date: Nov. 15, 2001

(54) Method and apparatus for building a memory image

(76) Inventors: Peter D. Petrov, Sofia (BG); Stephen J. Guerreri, Cary, NC (US)

Correspondence Address: Pillsbury Winthrop LLP, Intellectual Property Group, Ninth Floor, East Tower, 1100 New York Avenue, N.W., Washington, DC, 20005-3918, US

(21) Appl. No.: 09/794,246

(22) Filed: Feb. 28, 2001

Related U.S. Application Data
(60) Provisional application No. 60/185,704, filed on Feb. 29, 2000.

(51) Int. Cl. G06F 17/00

(52) U.S. Cl. 707/103 Y; 707/102

(57) ABSTRACT

A method and arrangement are provided for building an object file format image, in Common Object File Format, for use with a processor. A plurality of object files in Common Object File Format are received as input. An object file format image is created from the plurality of object files. The object file format image is then output.

This application receives the benefit of provisional application 60/185,704 filed Feb. 29, 2000, which is herein incorporated by reference in its entirety.

### RESERVATION OF COPYRIGHT

This patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

1. Field of the Invention

The present invention generally relates to an arrangement and method for building a memory image file for use with a processor.

2. Description of Background Information

Common Object File Format (COFF) is an accepted standard object file format. Commercial off-the-shelf (COTS) tools, such as compilers, assemblers, linkers and debuggers provide a user with an ability to build target executable code from source code and move the target executable code to a target processor for execution. A COTS software development tool, such as Texas Instrument's Code Composer Studio, allows a programmer to compile, assemble and link source code to produce a COFF file and to move the produced COFF file to a target processor for execution.

Typically, source code, such as C source code, is compiled to produce assembly code or a COFF object file, or assembly source code is assembled to produce a COFF object file. One or more COFF object files are then linked together to produce a COFF executable (an absolute, executable module). The COFF executable may then be loaded onto a target processor for execution.

Current COFF types support only one executable, for example, one process, in a COFF executable image. There is a need for the ability to allow many executable COFF images to be loaded onto a target processor, or multiple processors for execution using a single COFF image file that can be used with standard COTS tools.

### SUMMARY OF THE INVENTION

A method and arrangement are provided for building an object file format image, in Common Object File Format, for use with a processor. A plurality of object files in Common Object File Format are received as input. An object file format image is created from the plurality of object files. The object file format image is then output.

### BRIEF DESCRIPTION OF THE DRAWINGS

The invention is described using the following Figures in which:

FIG. 1 illustrates the Common Object File Format (COFF);

FIG. 2 shows a typical example of a COFF object file that contains three default sections, .text, .bss and uninitialized named sections;

FIG. 3A illustrates the file header structure of a COFF file;

FIG. 3B shows the possible values of flags indicated by bits 18-19 of the file header;

FIG. 4 illustrates the format of the COFF optional file header;

FIG. 5 shows the structure of a section header for a type 2 COFF file;

FIG. 6 illustrates how an executable COFF file is created using, for example, a C language compiler and an assembler;

FIG. 7 describes a new modified COFF structure that allows for multiple COFF executables to be included;

FIG. 8 is similar to FIG. 6, but includes an object image file creator to receive executable COFF files and to create a COFF object image including multiple COFF executables;

FIG. 9 illustrates the format of a modified COFF header;

FIG. 10 describes modified optional COFF header information;

FIG. 11 shows the format of reset section information;

FIG. 12 illustrates the structure of text section information;

FIG. 13 shows the format of a boot record;

FIG. 14 describes a format of a file descriptor table;

FIG. 15 shows an example of a module COFF header;

FIG. 16 shows an example of an optional module COFF header;

FIG. 17 describes a format of module section information;

FIG. 18 shows a structure of relocation entries;

FIG. 19 illustrates a possible configuration of an object image file creator;

FIG. 20 is a functional block diagram illustrating the object image file creator;

FIG. 21 is a functional block diagram illustrating an object file format image creator; and

FIGS. 22A and 22B are flowcharts which explain the processing of the object image file creator.

### DETAILED DESCRIPTION

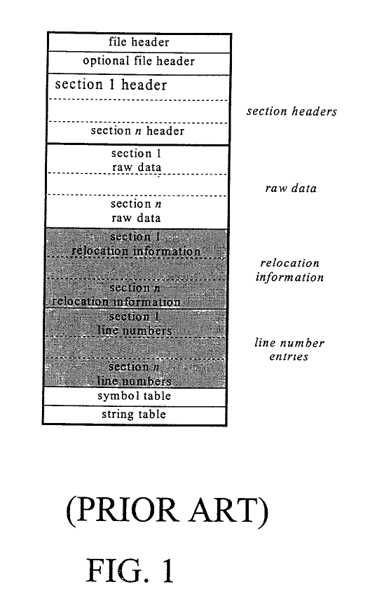

FIG. 1 illustrates the Common Object File Format. The format include a file header an optional file header, one or more section headers followed by raw data pertaining to each of the respective sections, and optionally relocation information for each of the respective sections, line numbers for each respective section, a symbol table and a string table. An assembler and linker, such as one which is available from Texas Instruments for the TMS320C3x/C4x processor, produce object files with the COFF structure shown in FIG. 1; however, a program that is linked for the final time will not contain relocation entries, unless relocation entries is explicitly specified for the linker.

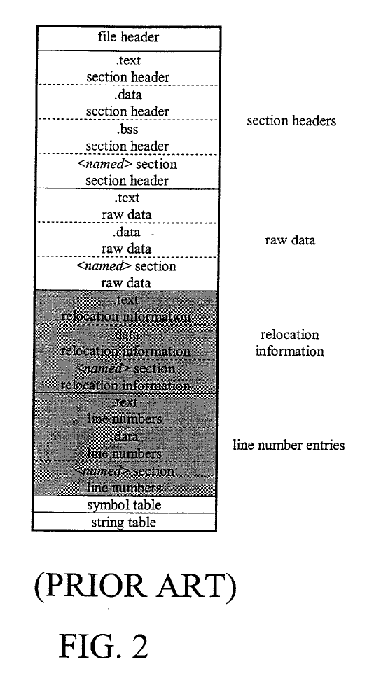

FIG. 2 illustrates the overall object file structure. FIG. 2 shows a typical example of a COFF object file that contains three default sections, .text, .data, .bss, and a named (section referred to as <named>). By default, the software tools place sections into the object file in the following order: .text, .data, initialized named sections, .bss and uninitialized named sections. Although uninitialized sections have section headers, they have no raw data, relocation information or line number entries. This is because directives, such as the .bss and .usect directives for Texas Instruments TMS320C3x/C4x assembler, simply reserve space for uninitialized data, which contain no actual code.

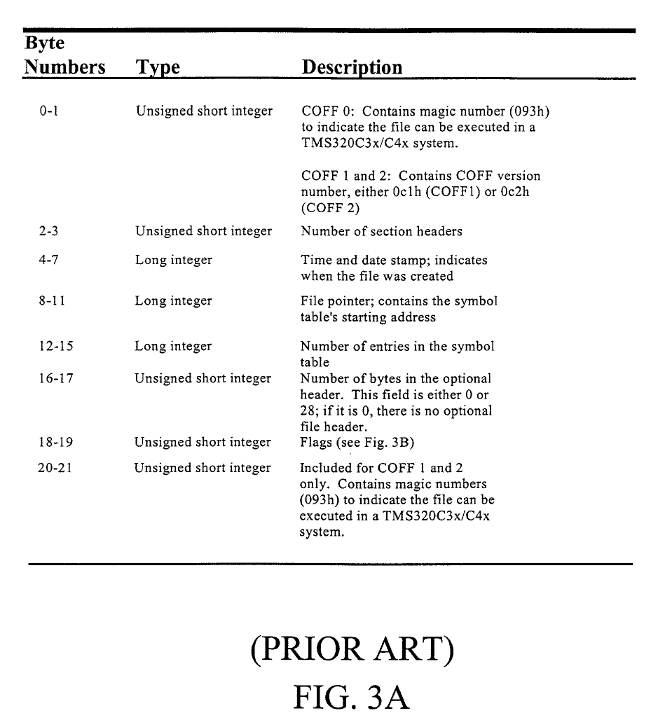

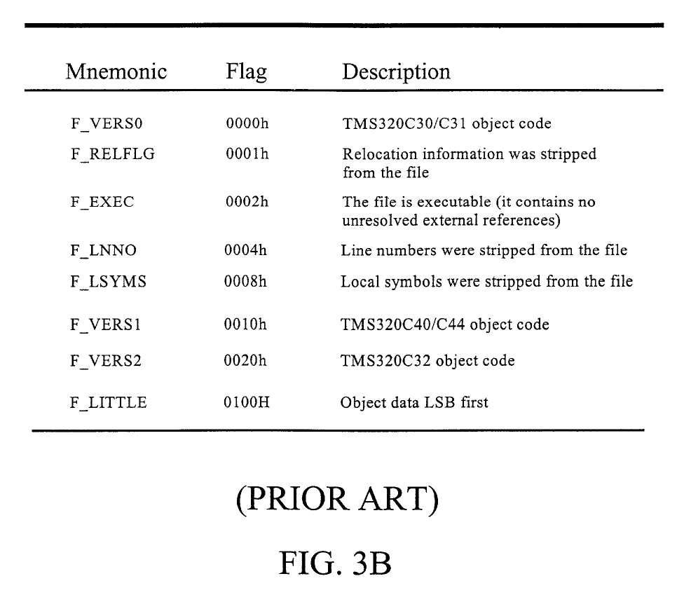

FIG. 3A illustrates the file header structure. Bytes 0 and 1 indicate the system on which the file can be executed or bytes 0 and 1 indicate COFF version number. Bytes 2-3 indicate the number of section headers. Bytes 4-7 provide a time and date stamp indicating when the file was created. Bytes 8-11 provide a pointer to a starting address of a symbol table. Bytes 12-15 indicate the number of entries in the symbol table. Bytes 16-17 indicate the number of bytes in the optional header. This will have a value of either 0 or 28. Bytes 18-19 are flags and bytes 20-21 are included for COFF 1 and 2 only and indicate the system upon which the file can be executed.

FIG. 3B indicates the possible values of the flags in bytes 18-19 of the file header. If the value of the flags does not include 0010 h and 0020 h the object code is for a particular processor as indicated with 0000 h in the figure. If the value of the bytes includes 0001 h, relocation information was stripped from the file. If the value of the bytes includes 0002 h, the file is executable and contains no unresolved external references. If the value of the bytes includes 0004 h, line numbers were stripped from the file. If the value of the bytes includes 0008 h, local symbols were stripped from the file. If the value of the bytes includes 0010 h, then the object code is for a particular processor, as indicated. If the value of the bytes includes 0020 h, then the object code is for a not her processor, as indicated. If the value of the bytes includes 0100 h, then the object data is ordered such that the least significant byte is first.

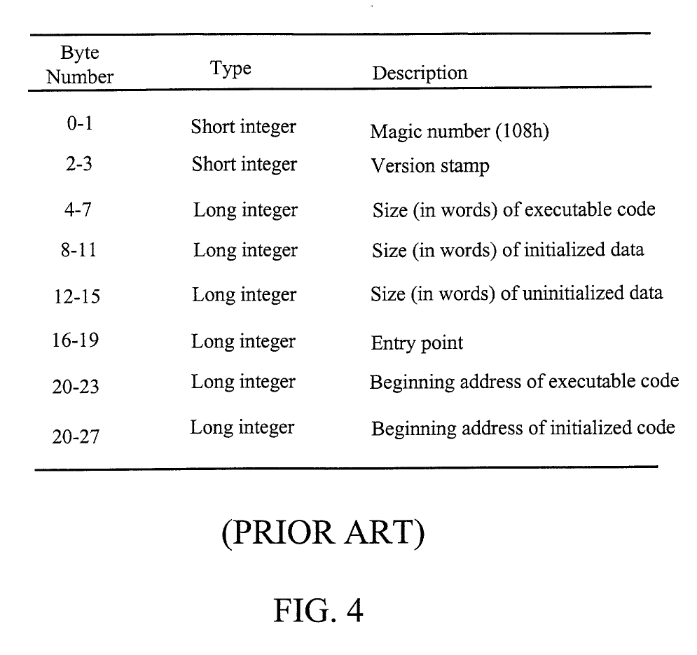

FIG. 4 illustrates the format of the optional file header. The linker, such as Texas Instruments TMS320C3x/C4x linker, creates the optional file header and uses it to perform relocation at download time. Partially linked files do not contain optional file headers. Bytes 0-1 of the optional file header include a magic number having a value 0108 h. Bytes 2-3 contain a version stamp. Bytes 4-7 contain the size, in words, of the executable code. Bytes 8-11 contain the size, in words, of initialized data. Bytes 12-15 contain the size, in words, of uninitialized data. Bytes 16-19 contain an address of the entry point of the code. Bytes 20-23 contain the beginning address of the executable code. Bytes 24-27 contain the beginning address of initialized data.

As can be seen from FIG. 1, COFF object files contain a table of section headers that indicate where each section begins in the object file. The COFF 0, COFF 1 and COFF 2 file types contain different section header information.

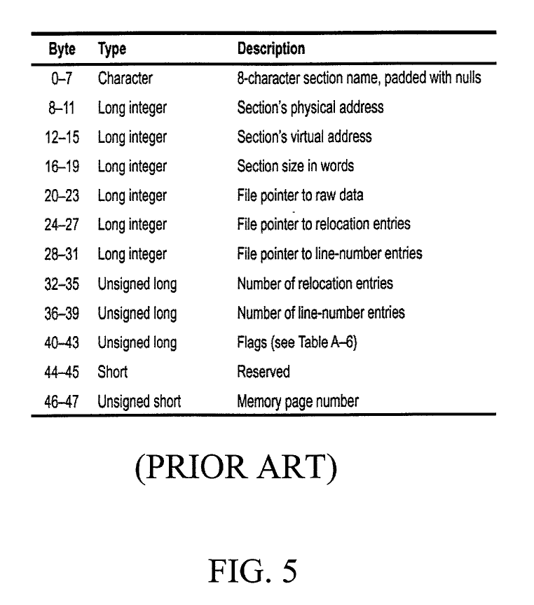

FIG. 5 illustrates the section header structure for COFF 2 files. Bytes 0-7 contain a section name, if used, padded with nulls. Bytes 8-11 contain the section's physical address. Bytes 12-15 contain the section's virtual address. Bytes 16-19 contain section size in words. Bytes 20-23 contain a pointer to raw data associated with the section. Bytes 24-27 contain a file pointer to relocation entries associated with the section. Bytes 28-31 contain a pointer to line number entries associated with the section. Bytes 32-35 contain the number of relocation entries. Bytes 36-39 contain the number of line number entries. Bytes 40-43 contain flags as defined in Table A-6 of TMS320C3x/C4x Assembly Language Tools User's Guide (Literature Number: SPRU035D, June 1998), herein incorporated by reference in its entirety. Bytes 44-45 are reserved. Bytes 46-47 contain a memory page number.

The assembler, for example, the Texas Instruments TMS320C3x/C4x assembler, treats each section as if it begins at address zero. All relocatable symbols (labels) are relative to address zero in their sections. Not all sections can exist at address zero in memory, therefore, the linker reallocates each section. Each section in a COFF object file has a table of relocation entries. The linker, for example, the Texas Instruments TMS320C3x/C4x linker, usually removes these entries after it uses them. In an embodiment of the invention using the Texas Instruments TMS320C3x/C4x linker, the -r linker option is used to retain the relocation entry information. This information is used by an object image file creator to relocate the relocatable entries to absolute locations when building an image file.

The object file may contain a table of line number entries that are useful for symbolic debugging. For example, when a C compiler produces several lines of assembly language code, the C compiler creates a line number entry that maps these lines back to the original line of C source code that generated them. Each single line entry contains 6 bytes of information.

The use of static variables is recommended. Static variables refer to symbols defined in, for example, C language that have a storage class static outside of any function. For example, if several modules use symbols with the same name, making them static confines the scope of each symbol to the module that defines the symbol, thus eliminating multiple definition conflicts. The entry for each symbol in the symbol table contains the symbols:

Name (or pointer into the string table)

Type

Value

Section the symbol was defined in

Storage Class

Basic type (integer, character, etc.)

Derived type (array, structure, etc.)

Dimensions

Line number of the source code that defined the symbol

Section names are also defined in the symbol table. All symbol entries, regardless of class and type, have the same format in the symbol table. Each symbol table entry contains 18 bytes of information in this embodiment. Each symbol may also have an 18-byte auxiliary entry. In this embodiment, special symbols have an auxiliary entry. Some symbols may not have all the characteristics listed above. If a particular field is not set, it is set to null.

Symbol names that are longer than eight characters are stored in a string table. The field in the symbol table entry that would normally contain the symbol's name contains, instead, a pointer to the symbol's name in the string table. Names are stored contiguously in the string table, delimited by a null byte. The first four bytes of the string table contain the size of the string table in bytes; thus, offsets into the string table are greater than or equal to four.

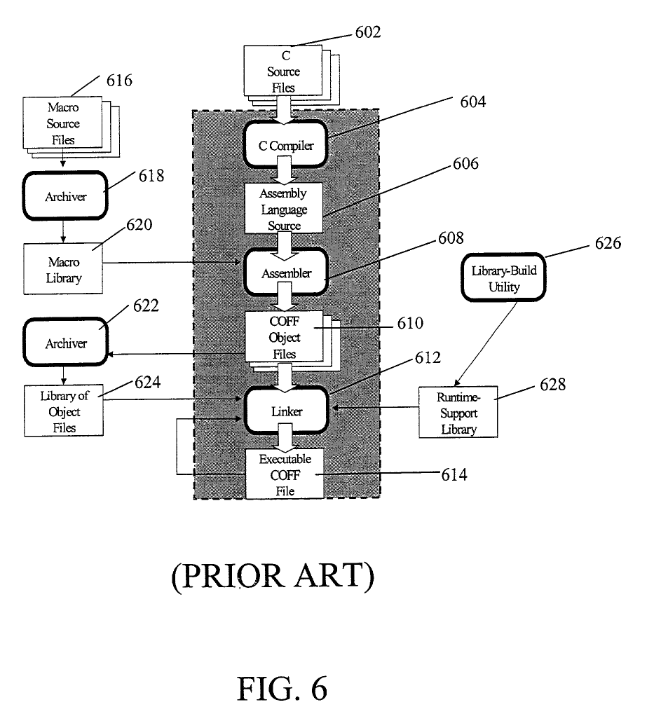

FIG. 6 helps to explain how an executable COFF file is created using, for example, a C language compiler and an assembler. Source files 602 are input to a C compiler 604, which produces assembly language source code 606. Assembler 608 assembles the assembly language source code and produces COFF object file 610. Macro source files 616 may be input to archiver 618 to produce macro library 620. Macro library 620 may be used by assembler 608 to expand any macros contained in the source code. Further, COFF object file 610 may be input to an archiver 622 which produces a library of object files 624 which can be used by linker 612. Linker 612 may also receive COFF object file 610 and a runtime support library 628, created by a library build utility 626, to produce an executable COFF file 614.

For more detailed information on this process please refer to Texas Instrument's documents TMS320C3x/C4x Optimizing C Compiler User's Guide (Literature Number: SPRU034H—June 1998), herein incorporated by reference, and TMS320C3x/C4x User's Guide (Literature Number: SPRU063C—May 1999), herein incorporated by reference.

In an embodiment of the invention, it is recommended that all C programs be linked with an object module, such as boot.obj. When a program begins running, it first executes boot.obj, which contains code and data for initializing the runtime environment. The linker, for example, the Texas Instruments TMS320C3x/C4x linker, automatically extracts boot.obj and links it when the linker is used with a -c or -cr option and includes rts.lib, the runtime support library, in the link. Boot.obj is an object within rts.lib provided with Texas Instruments' tools. The linker generates executable COFF object modules. The linker Combines multiple COFF object files into a single executable COFF object module. In other words, one executable COFF object module is provided for one target process.

The linker produces executable COFF object modules. An executable object file has the same COFF format as object files that are used as linker input; however, the sections in an executable object file are combined and relocated to fit into target memory. In order to run a program, the data in an executable object module must be transferred or loaded into the target system memory. Several methods can be used for loading the program, depending on the execution environment. Some of the more common ways to load a program are as follows:

The TMS320C3x/C4x debugging tools, which are included with the software simulator, XDS emulator, and the software development system, have built-in-loaders. Each of these tools have a LOAD command to invoke a COFF loader. The loader reads the executable file and copies the program into target memory.

An object format converter, which is shipped as part of the assembly language package, can be used to convert the executable COFF object module into one of several hexadecimal object file formats. The converted file can then be used with an EPROM programmer to bum the program into an EPROM.

Some TMS320C3x/C4x programs may be loaded under the control of an operating system or monitor software running directly on a target system. The target system usually has an interface to a file system on which the executable module is stored. This type of system requires a custom loader. The custom loader must be able to comprehend the file system (in order to access the file) as well as the memory organization of the target system (to load the program into memory).

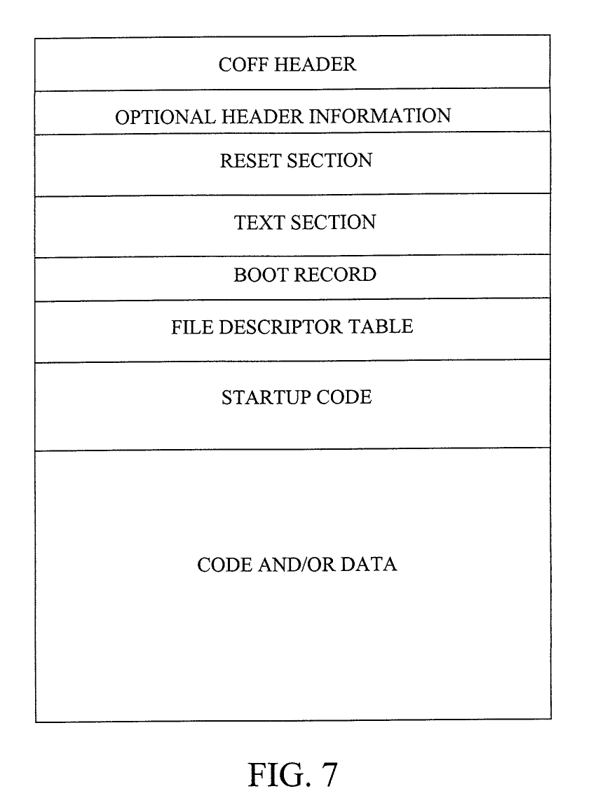

FIG. 7 describes new modified COFF structures that allow for multiple COFF executables to be included. The integrity of the COFF file is maintained as well as its format, so that standard COFF utility programs will be able to process and load the file for execution.

As can be seen in FIG. 7, the modified COFF structure includes a COFF header, optional header information, a reset section, a text section, a boot record, a file descriptor table, and startup code followed by code and/or data.

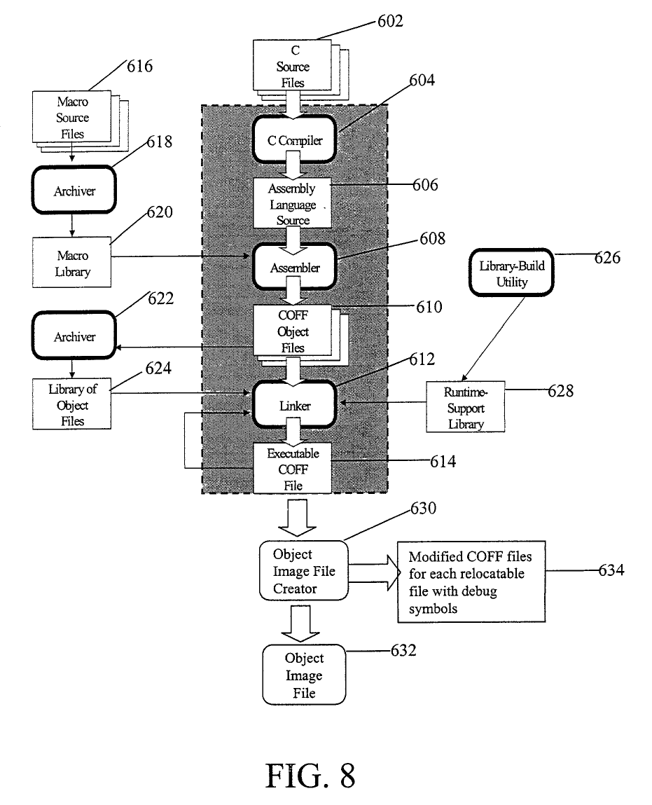

FIG. 8 is similar to FIG. 6, but includes object image file creator 630, which receives executable COFF files and combines the executable COFF files into an object image file 632 with a structure as shown in FIG. 7. The object image file creator may also produce modified COFF files for each relocatable file with debug symbols 634.

The following explains the linking requirements to produce a relocatable COFF executable. The compiler/linker command options are included as examples from Texas Instruments' TMS320C3x/C4x code generation tools version 5.10.

All input modules should be linked using the -ar linker option to produce an absolute relocatable option module.

All input modules should be linked using the -c linker option, which specifies the ROM autoinitialization model. Using the ROM autoinitialization model, the .cinit section will remain in the output file and the initialized data will be set up at run time by module startup code.

Every input module must be linked with a proper startup file.

It is recommended that the -x linker option for exhaustive read of input libraries be used.

It is recommended that the -o linker option be used to name the output COFF file, which will subsequently be used as an input module file for system building. The output file name should have a suffix different from the default .out, which is reserved for output module files produced by the system builder. The suffix .rel is recommended.

The -s linker option should not be used because it strips the symbol table and line number entries.

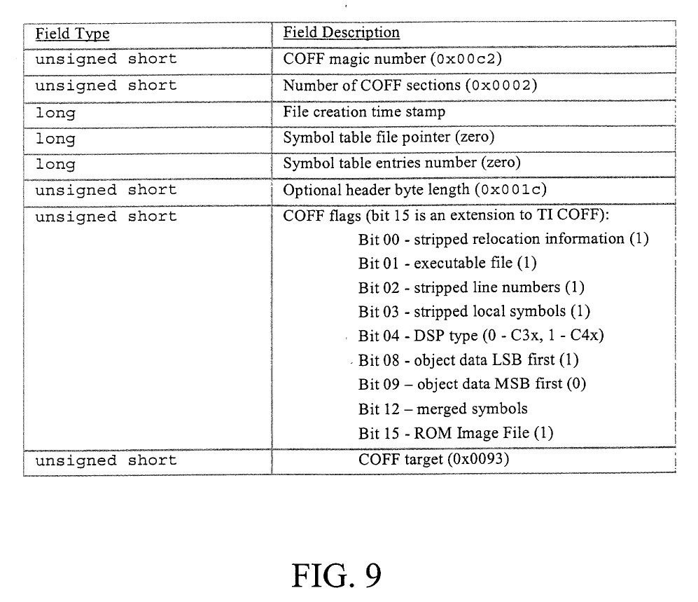

FIG. 9 illustrates the format of the modified COFF header. The modified COFF header includes COFF magic number (0x00c2), number of COFF sections, which is (0x0002), the file creation time stamp, the symbol table file pointer, which should be zero, the symbol table entries number, which also should be zero, an optional header byte length, which is 0x001c, a series of flags, as indicated in FIG. 9, and a value indicating the COFF target.

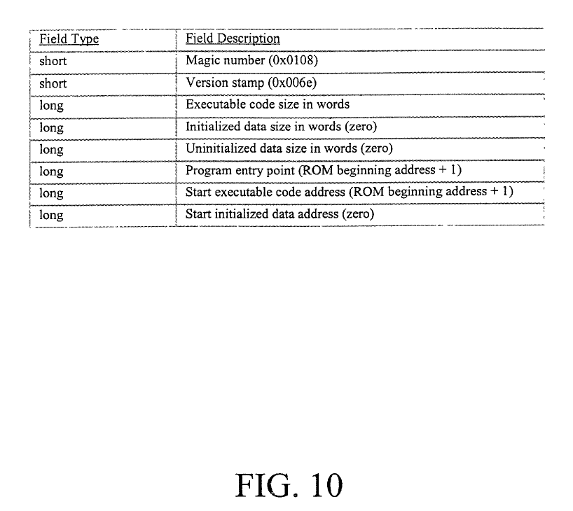

FIG. 10 illustrates the modified optional COFF header information. The optional header information includes a magic number (0x0108), a version stamp (0x006e), executable code size and words, initialized data size in words (zero), uninitialized data size in words (zero), program entry point (which when using ROM is the ROM beginning address +1), start executable code address (which when using ROM is the beginning address +1), and the start initialized data address (zero).

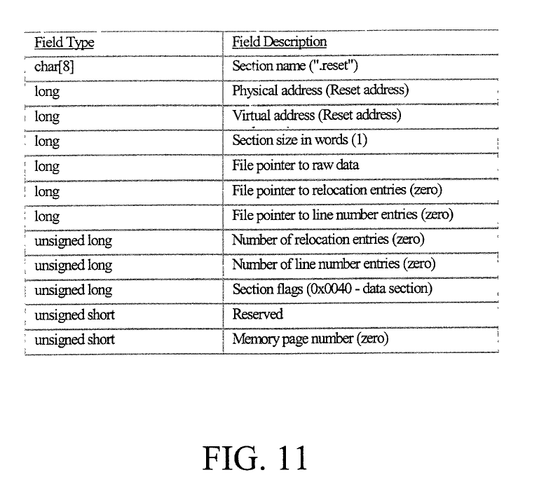

FIG. 11 provides the format of the reset section information. It is assumed that if the execution of the system is performed directly from ROM, the address written in this location will be loaded into the program counter at CPU power up. The value of this word is the ROM beginning address plus one. If the CPU must start to execute another code (e.g. for boot loading) this section remains unused. The reset section information includes up to eight characters for the section name (“.reset”), a physical address (reset address), a virtual address (reset address), section size in words (one), file pointer to raw data, file pointer to relocation entries (zero), file pointer to line number entries (zero), number of relocation entries (zero), number of line number entries (zero), section flags (0x0040—data section), a reserved word and memory page number (zero).

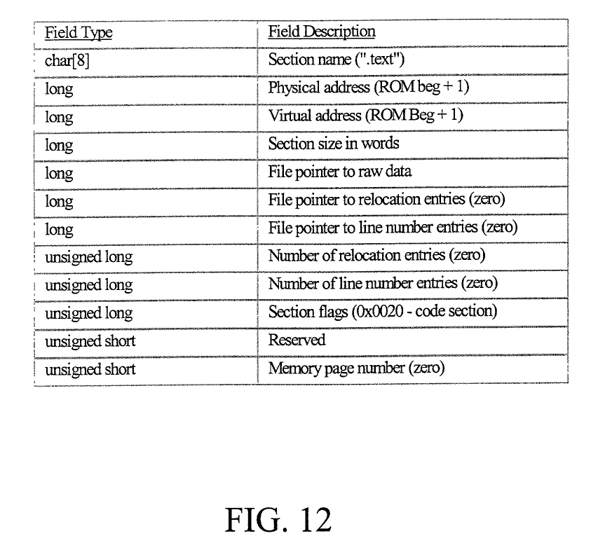

FIG. 12 illustrates the structure of the text section information. The text section contains the file system as raw data. The first eight bytes of the text section information include the section name (“.text”) padded with nulls. Next is the physical address (ROM beginning address +1), the virtual address (ROM beginning address +1), section size in words, file pointer to raw data, file pointer to relocation entries (zero), file pointer to line number entries (zero), number of relocation entries (zero), number of line number entries (zero), section flags (0x0020—code section), a reserved word and memory page number (zero).

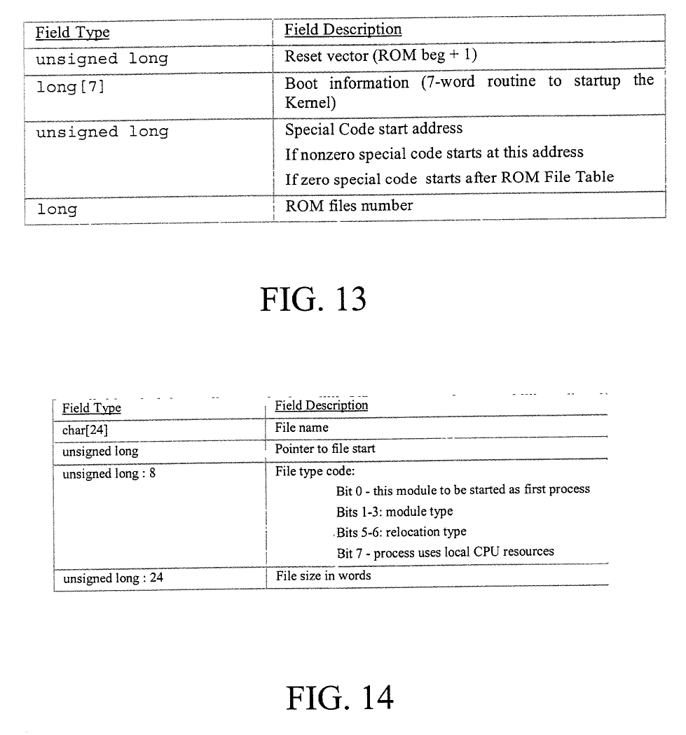

FIG. 13 illustrates the format of the boot record. The first four bytes of the boot record are the reset vector, which is equal to the address of the beginning of ROM +1 for an image burned in ROM. The reset vector defines the address to which controls should pass upon a reset. The next seven words are reserved for the boot information. The following is an example of a seven-word program, which may make up the boot information. Sample Boot program used to generate Boot information contents.

.text
.word 0

RomBoot:

| .if | .TMS320C40 == 0 | |
|---|---|---|
| ldi | 809ch/4, sp | |
| .else | | |
| ldi | 2ffch/4, sp | |
| .endif | | |
| .lsh | 10, sp | ; Init stack in internal RAM1 |
| callu | RomAddr | |

RomAddr:

| pop | ar2 | |
|---|---|---|
| ldi | *+ar2 (Kstart − RomAddr), r0 | |
| bnz | r0 | |
| bu | $+1 | ; Start offset to be added |

Kstart:

The above boot program is written in Texas Instruments TMS320C3x/C4x assembly language, but could be written in any assembly language for the target processor. This particular program initializes the stack, loads the beginning address of the startup code into a register and then branches to the beginning of the startup code.

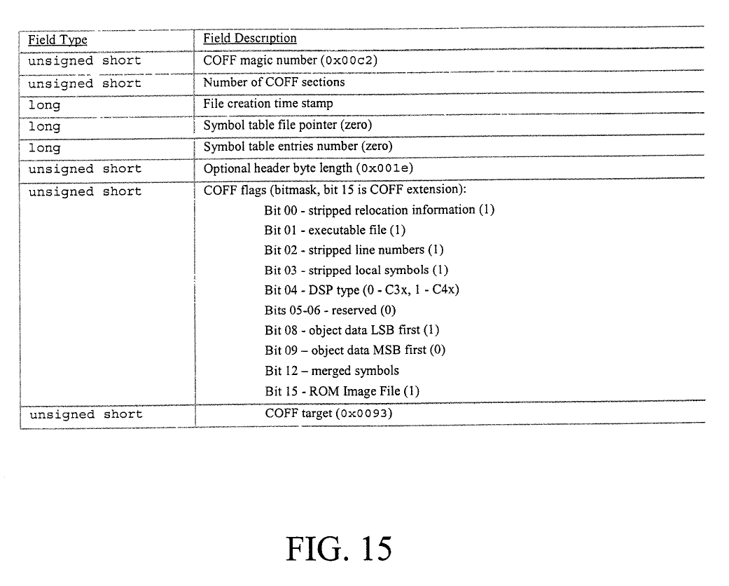

FIG. 14 shows the format of the file descriptor table. The file descriptor table specifies all the files in the ROM file system. The table represents an array of structures as shown in FIG. 14. The first entry in the structure is a 24-byte long file name. The file name is padded, as necessary, with nulls after the last character of the file name. The next four bytes point to the start of the file in ROM. The lowest eight bits of the next word contain the file type code. Bit zero indicates that this module is to be started as the first process. Bits 1-3 indicate the module type. Many different module types can be defined. Bits 5-6 indicate the relocation type, if bits 5-6 have the value 00, this indicates a load executable relocatable module. If the bits have a value 01, this indicates a ROM executable absolute module. If the bits have a value 10, this indicates a RAM executable absolute module. If bits 5-6 have a value 11, this indicates RAM executable relocatable module. Bit 7 indicates whether the process uses local CPU resources. The highest twenty-four bits of the same word indicate the file size in words.

Following the file descriptor table is a startup code. The startup code can be written to perform a variety of functions. For example, the startup code may start the various modules in ROM or may relocate some or all of the modules to different locations in RAM and start execution of the modules.

The purpose of the startup code is similar to a popular zip utility for combining and compressing multiple files on a personal computer. For example, one option of the zip utility is to add executable code to the combined file, which makes it an executable file on the system on which it resides. This added code contains the information that separates and decompresses the contents back to individual files. This is similar in purpose to the startup code which separates the various COFF files and either starts the execution of these files and/or relocates the files to different portions of memory for execution.

In an embodiment of the invention, the startup code is a Kernel of an operating system and the modules are executed by the operating system. The process modules may be Portable Operating System Interface (POSIX) processes with an extension to allow dynamic binding to shared libraries. The processes are represented by a separate address space, one or more threads of control which execute in the address space, and the system resources to support the processes.

One type of module supported in this embodiment is a process driver module which is similar to an ordinary process implicitly spawned by the Kernel at system startup. This module type exports a set of functions via an interface section, used by the operating system to communicate with the process driver. Direct access from other modules to process driver modules is not allowed. Process drivers represent a powerful means to provide device driver services using active entities such as processes and/or threads (including multi-threaded implementations).

A shared library module includes one or more programs that are loaded on demand when another module is loaded, and are dynamically bound to the loaded module. This module type exports a dedicated interface structure through which other modules may use shared library services. Shared libraries provide a means to share code and data among multiple processes.

A library driver module is equivalent to the shared library module, but is not intended to be loaded on demand and dynamically bound to other modules. Instead, library driver modules which are part of, for example, a ROM file system, are loaded by the Kernel at system startup and initialized. Their exported section conforms to a special protocol used by the Kernel to communicate with the library device driver. No direct access from other modules to library device drivers may be allowed. Library device drivers are passive entities, which provide device driver services and thus follow the conventional stereotype for device drivers.

A kernel extension module is intended to extend the operating system Kernel with additional capabilities. Kernel extension modules are not processes and do not export sections as library modules. They are loaded implicitly by the Kernel at system startup if they reside in, for example, the ROM file system, or explicitly on demand by a process. They may be unloaded also on demand. The loaded Kernel extension module offers a set of functions to provide different services related to file system operation. These functions are used only by the Kernel to communicate with the Kernel extension. No direct access from other modules to Kernel extensions is allowed.

Different module relocation types may be used to provide a debugging run-time environment which is as close as possible to a final production environment of the user, supporting different run-time models.

A production system stored in ROM and executing from ROM is supported by the ROM-absolute module type.

A production system stored in ROM and executing from RAM (because RAM is faster than ROM) is supported by a RAM-absolute module type.

A production system executing multiple instances of a same process is supported by the RAM-relocatable module type.

A production system executing arbitrary modules from external storage, for example, flash-ROM disk, magnetic card, etc., is supported by a load-relocatable module type.

The ROM-absolute and RAM-absolute module types are especially well suited for source debugging because symbol information is available.

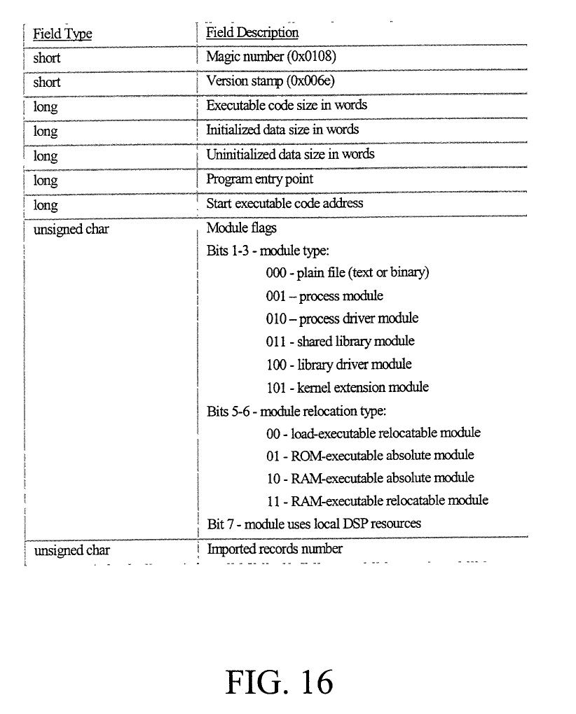

FIG. 15 shows an example of a module COFF header. The first sixteen bits contain a COFF magic number having a value of 0x00c2. The next sixteen bits contain a number indicating the number of COFF sections. The next word contains a file creation time stamp. The following word contains a pointer to the symbol table; however, because no symbol table is included, this value will be zero. The next word is reserved for the number of entries in the symbol table, which in this case is zero. The following sixteen bits contain the optional header byte length, which in this case is a value of 0x001e. The following sixteen bits contain bit flags as indicated in FIG. 15. The next sixteen bits indicate the COFF target and have a value of 0x0093.

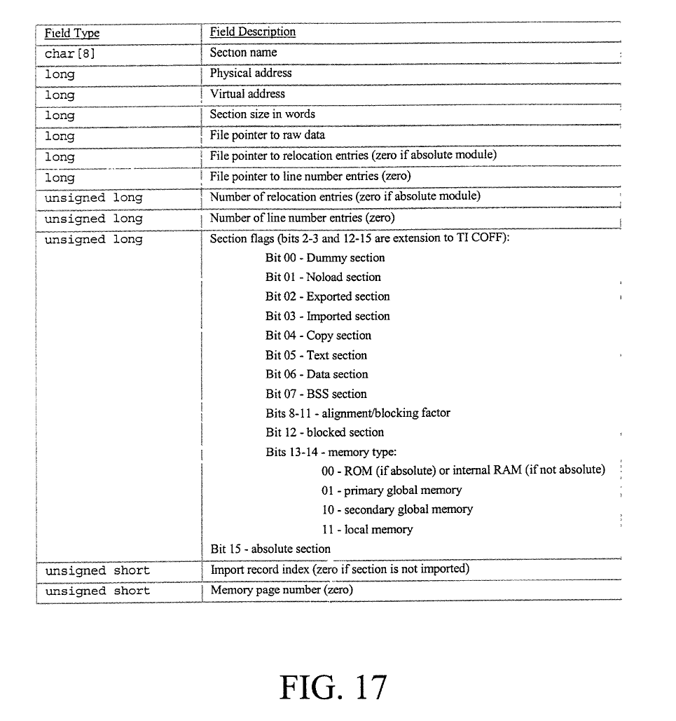

FIG. 16 indicates the format of the optional module header. The first sixteen bits contain a magic number having a value 0x0108. The next sixteen bits contain a version stamp, which in this embodiment has a value of 0x006e. The following word contains the size, in words, of the executable code. The next word contains the initialized data size in words. The following word contains the uninitialized data size in words. Following is a word which includes a pointer to the program entry point. Next is the start address of the executable code. The next byte is a flag, in which bits 1-3 indicate module type, as explained in FIG. 16, bits 5-6 define the module relocation type, and bit 7 indicates whether the module uses local DSP resources. The next byte provides an imported records number.

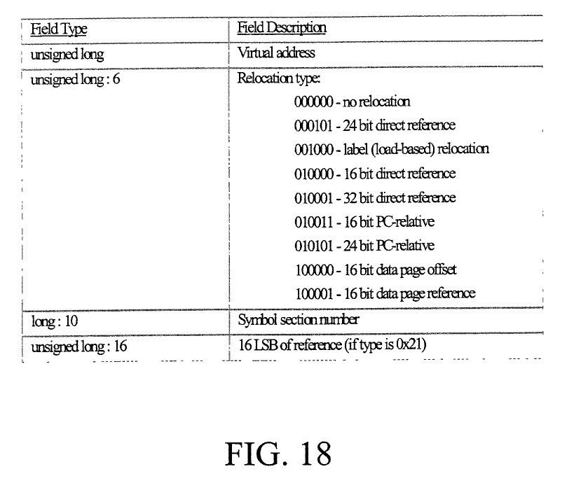

FIG. 17 illustrates the format of a module section header. The first eight bytes include the section name, padded on the right with null characters as needed. The next word contains a physical address of the code or data. The following word contains the virtual address of the code or data. The next word contains the section size in words. The following word contains a pointer to the raw data. Next is a word containing a pointer to relocation entries. The pointer is zero if the module is an absolute module. The following word is a pointer to line number entries, which is zero if there are no line number entries. The following word contains the number of relocation entries, which is zero for an absolute module. The following word contains the number of line number entries, which is zero if there are no line number entries. The next word contains flags as indicated in FIG. 17. The next sixteen bits include an import record index or zero if this section is not imported. The next sixteen bits include a memory page number, which in this case is zero.

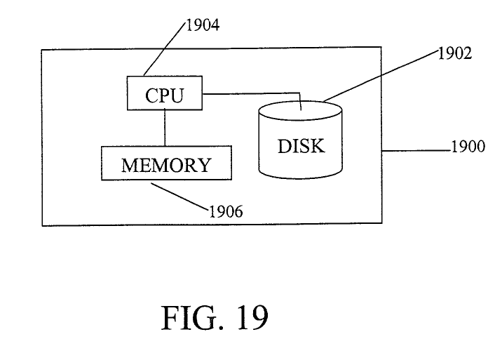

If relocation information is included it is included after all the sections' raw data for each of the sections sequentially. Relocation entries are modified with respect to the COFF format. Every relocation entry has the structure shown in FIG. 18.

The first word of the structure is the virtual address of the relocation entry. The lowest 6 bits of the next word is the relocation type, as indicated in FIG. 18. The following 10 bits of this word contain the symbol section number. The last 16 bits of the word contain the sixteen least significant bits of the reference necessary to compute the full address of the reference when the address information in the relocated machine instruction is limited to the most significant address bits.

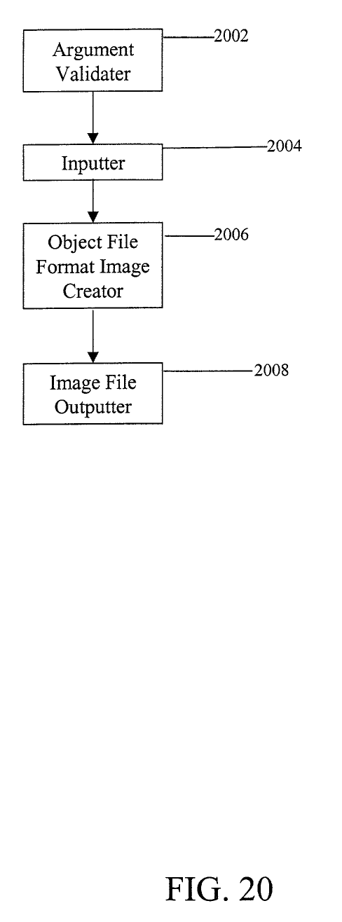

FIG. 19 provides an example of a computer 1900, which may serve as the object image file creator. Computer instructions reside on a medium, such as a hard disk 1902, a CD-ROM, a read only memory, or any other well known machine-readable medium. Computer 1900 includes a CPU for executing program instructions and a memory 1906, such as a Random Access Memory.

The object image file creator may be invoked with various arguments. The arguments may be options or they may be the name of a command file, which includes options. The various options may be as follows: quiet mode (no progress messages), reset vector address, code start address, ROM start hexadecimal address and start hexadecimal size, generate ROM image map file, start process module name.

Module options include: big memory model (BSS section need not fit in a 64K byte memory block), ROM absolute module, RAM absolute module, RAM relocatable module, process module, shared library module, library driver module, process driver module, Kernel extension module, plain file. Configuration options may be specified such as: number of CPUs in the system, the maximum number of processes in the system, internal interrupt stack size, internal timer interrupt clock, processor cache enabled, system timer clock in nanoseconds, system timer interrupt in nanoseconds, round robin scheduling in nanoseconds, interprocessor interrupt number, number of blocks in the memory file system, and number of inodes in the memory file system.

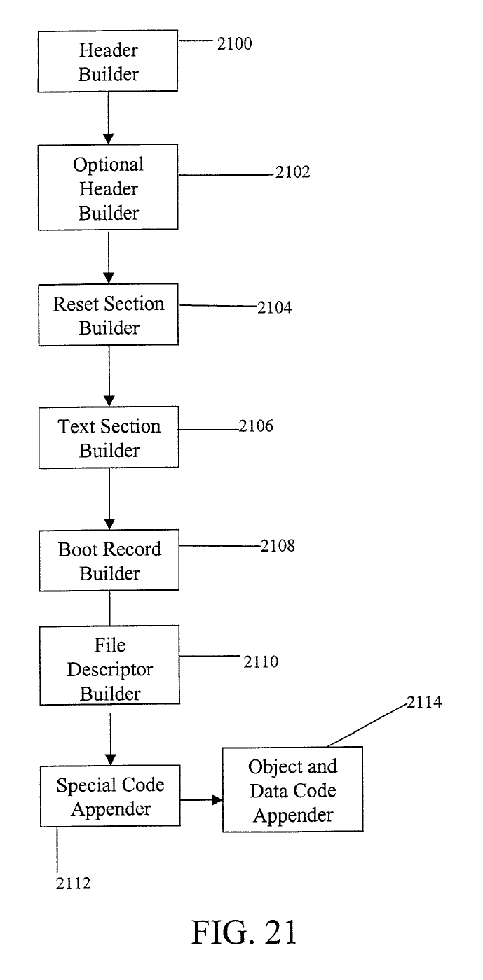

FIG. 20 illustrates, in functional blocks, the object image file creator. The object image file creator may include an argument validater 2002 to validate input arguments, as previously discussed, an inputter 2004 to input the executable COFF files, an object file format image creator 2006 to create the object image file based on the input executable COFF files, and an image file outputter 2008 to output the object image file.

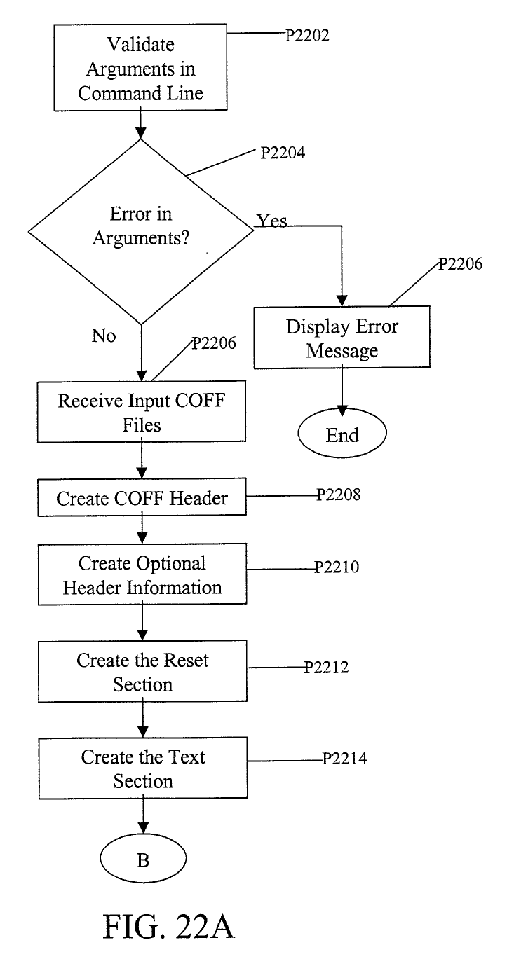

A more detailed view of the object file format image creator 2006 is shown in FIG. 21. The object file format image creator includes a header builder 2100 to build a modified COFF header, an optional header builder 2102 to build a modified optional header, a reset section builder 2104 to build a reset section, a text section builder 2106 to build a text section, a boot record builder 2108 to build a boot record, a file descriptor builder to build a file descriptor, a special code appender to 2112 to append startup code to the created COFF file image, and an object and data code appender 2114 to append any object and data code to the created COFF image. The object and data code appender may include a module builder (not shown) to build and append a module COFF header, an optional module COFF header and a module section header along with any associated object and data code.

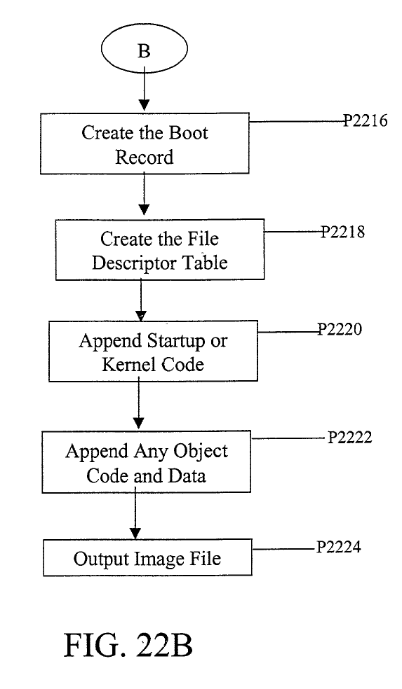

FIGS. 22A and 22B explain the processing of the object file format image creator.

At P2202, arguments included with the command line for initiating the object image format creator are validated.

At P2204, if an error in the arguments was detected, P2206 will be performed to display an error message.

If, at P2204, it is determined that there are no errors in the arguments, then P2206 will be performed to receive the input executable COFF files.

At P2208, the modified COFF header is created.

At P2210, the modified optional header information is created and appended to the output COFF image.

At P2212, the reset section is created and appended to the COFF image.

At P2214, the text section is created and appended to the COFF image.

At P2216, the boot record is created and appended to the COFF image.

At P2218, the file descriptor table is created and appended to the COFF image.

At P2220, startup or kernel code is appended to the COFF image.

At P2222, any object and data information is appended to the COFF image. The object and data information may include a module COFF header, an optional module COFF header and a module section header along with any associated object and data code.

At P2224, the COFF image file is output.

COFF format was used as an example. In fact any other standard format may also have been used. The suggested values in the different COFF structures were given as examples and are not meant to be limiting. In fact other values or other ordering of the information may also be used.

Examples were presented using the Texas Instruments TMS320C3x/4x processor as an example; however, any processor and development tools which support a standard format, such as COFF may also have been used.

While the invention has been described with reference to certain illustrated embodiments, the words which have been used herein are words of description, rather than words limitation. Changes may be within the preview of the appended claims without departing from the scope and spirit of the invention in its aspects. Although the invention has been described herein with reference to particular structures, acts, and materials, the invention is not to be limited to the particulars disclosed but rather extends to all equivalent structures, acts, and materials, such as are within the scope of the appended claims.

We claim as our invention:

1. A method for building an object file format image for use with a processor, the object file format image conforming to a standard object file format, the method comprising:
receiving, as input, a plurality of object files, each of the object files conforming to the standard object file format;
creating the object file format image including information from the plurality of object files; and
outputting the object file format image, wherein
the standard object file format is Common Object File Format.

2. The method of claim 1, wherein each of the received object files include at least one of relocatable object code and relocatable data.

3. The method of claim 1, wherein the outputting comprises outputting the object file format image in a form suitable for writing to a Read Only Memory.

4. The method of claim 1, wherein the outputting comprises outputting the object file format image in a form suitable for writing to a Random Access Memory.

5. The method of claim 1, further comprising:
outputting a second object file format image conforming to the standard object file format, the second object file format image including symbol information for use with a debugging tool and at least one of object code and data.

6. The method of claim 1, wherein the created object file format image includes object code for extracting different portions of information stored in the created object file format image and causing the different portions to be copied to respective areas of at least one memory.

7. The method of claim 1, wherein the created object file format image includes absolute relocated code to be written to a Read Only Memory, the absolute relocated code having been relocated such that it is adapted to be loaded into and executed from a different portion of a memory.

8. The method of claim 1, wherein the created object file format image includes absolute relocated code to be executed from a Read Only Memory.

9. An arrangement for building an object file format image for use with a processor, the object file format image being arranged to conform to a standard object file format, the arrangement comprising:
an inputter to receive a plurality of object files as input, each of the object files being arranged to conform to the standard object file format;
an object file format image creator to create the object file format image from the plurality of object files; and
an outputter to output the object file format image,
wherein the standard object file format is Common Object File Format.

10. The arrangement of claim 9, wherein the object file format image creator comprises:
a first header builder to build a header conforming to the standard object file format;
a second header builder to build a second header conforming to an optional header of the standard object file format;
a first section builder to build a first section header, the first section to be used when execution is to be performed directly from a Read Only Memory;
a second section builder to build a second section header, the second section header being for a second section including a plurality of separately executable programs; and
a boot record builder to build a boot record, the boot record including instructions for a processor to execute a startup program.

11. The arrangement of claim 10, wherein the startup program includes instructions for the processor to extract different portions of information stored in the created object file format image and to cause the different portions of the information to be copied to respective areas of at least one memory.

12. The arrangement of claim 9, wherein the received object files include at least one of relocatable object code and relocatable data.

13. The arrangement of claim 9, wherein the outputter is arranged to output the object file format image in a form for writing to a Read Only Memory.

14. The arrangement of claim 9, wherein the outputter is arranged to output the object file format image in a form for writing to a Random Access Memory.

15. The arrangement of claim 9, wherein the outputter is arranged to output a second object file format image conforming to the standard object file format, the second object file format image including symbol information for use with a debugging tool and at least one of object code and data.

16. The arrangement of claim 9, wherein the outputter is arranged to output the object file format image including absolute relocated code to be written to a Read Only Memory, the absolute relocated code having been relocated such that it is adapted to be loaded into and executed from a different portion of a memory.

17. The arrangement of claim 9, wherein the outputter is arranged to output the object file format image including absolute relocated code to be executed from a Read Only Memory

18. A machine-readable medium comprising information stored therein, such that when the information is read into and executed by a machine, the machine is caused to:
receive as input a plurality of object files, each of the object files conforming to the standard object file format;
create the object file format image from the plurality of object files; and
output the object file format image, wherein
the standard object file format is Common Object File Format.

19. The machine-readable medium of claim 18, wherein each of the received object files include at least one of relocatable object code and relocatable data.

20. The machine-readable medium of claim 18, wherein the object file format image to be output is adapted to be in a form suitable for writing to a Read Only Memory.

21. The machine-readable medium of claim 18, wherein the object file format image is adapted to be in a form suitable for writing to a Random Access Memory.

22. The machine-readable medium of claim 18, wherein the information further comprises instructions to cause the machine to:
output a second object file format image conforming to the standard object file format, the second object file format image including symbol information for use with a debugging tool and at least one of object code and data.

23. The machine-readable medium of claim 18, wherein the created object file format image includes object code for extracting different portions of information stored in the created object file format image and causing the different portions to be copied to respective areas of at least one memory.

24. The machine-readable medium of claim 18, wherein the created object file format image includes absolute relocated code to be written to a Read Only Memory, the absolute relocated code having been relocated such that it is adapted to be loaded into and executed from a different portion of a memory.

25. The machine-readable medium of claim 18, wherein the created object file format image includes absolute relocated code to be executed from a Read Only Memory.

26. A machine-readable medium comprising:
a COFF image file, the COFF image file including a boot record comprising instructions for a processor to start a startup program.

27. The machine-readable medium of claim 26, wherein the instructions cause a program to extract different portions of information stored in the COFF image file and to copy the different portions to respective areas of at least one memory.

28. The machine-readable medium of claim 26, wherein the instructions cause a program to start execution of a plurality of programs, the programs being stored in the COFF image file.

29. The machine-readable medium of claim 27, wherein the different portions of information each include a different program for at least one processor and the startup program starts each of the different programs in the respective areas of the at least one memory.
